(19) United States
(12) Patent Application Publication
(10) Pub. No.: US 2023/0334131 A1
(43) Pub. Date: Oct. 19, 2023

(54) BIOMETRICALLY PROTECTED DEVICE

(71) Applicant: ZWIPE AS, Oslo (NO)

(72) Inventor: Anthony SIMS, Colorado Springs, CO (US)

(21) Appl. No.: 17/753,883

(22) PCT Filed: Oct. 1, 2020
(86) PCT No.: PCT/EP2020/077570

§ 371 Date: Mar. 17, 2022

Related U.S. Application Data
(60) Provisional application No. 62/908,836, filed on Oct. 1, 2019.

(30) Foreign Application Priority Data
Oct. 31, 2019 (GB) 1915845.0

(51) Int. Cl. G06F 21/32; G06F 21/35; G06F 21/77

(52) U.S. Cl. CPC G06F 21/32; G06F 21/35; G06F 21/77

(57) ABSTRACT

A biometrically protected device including a secure element, for communications with a secure server, a biometric authentication system including a biometric sensor, wherein the biometric authentication system is for controlling access to one or more protected feature(s) of the device, and a power interface for receiving power from an external source and for powering both of the secure element and the biometric authentication system. The biometrically protected device is arranged such that the biometric authentication system remains inactive until the power interface receives power and the secure element provides a command message to the biometric authentication system. The command message is not provided unless the secure element has made a secure connection with the secure server.

The present invention relates to a biometrically protected device with a secure element, and to a method for biometric authorisation of a user using such a biometrically protected device.

Biometrically protected devices such as fingerprint authorised smartcards or wearables are becoming increasingly more widely used. Smartcards for which biometric authorisation has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID or NFC. These cards can interact with sensors to communicate information in order to enable access, to authorise transactions and so on. Similar systems have been proposed for wearables, such as for smart watches or smart straps for watches. Other devices are also known to make use of biometric authorisation such as fingerprint authorisation, and these include control tokens for various purposes including computer memory devices, building access control devices, military technologies, vehicle keys and so on.

Even with the use of a biometric sensor it is expected that there will still be attacks on the security of the device with attempts being made to access protected features of the device despite the presence of a biometric authentication system. Such attacks include physical attacks on the integrity of the device as well as computer based “hacking” of the device and/or the external systems that interact with the device. Some protection can be provided by the use of encrypted communications between the device and external systems. Encrypted data transfer between internal processors or controllers of the device has also been proposed. Nonetheless there remains an on-going need to improve the resistance to security attacks of biometric protected devices.

One disclosure of a biometrically protected device can be found in WO2017/149022. In this publication the example is a fingerprint protected smartcard. When the smartcard is able to obtain power, such as via contactless power harvesting, then a fingerprint authentication system is powered up and the user must confirm their identity via an enrolled fingerprint before it is possible to access protected features of the smartcard, such as a payment function for a bank card.

Viewed from a first aspect, the invention provides a biometrically protected device comprising: a secure element for communications with a secure server; a biometric authentication system including a biometric sensor, wherein the biometric authentication system is for controlling access to one or more protected feature(s) of the device; and a power interface for receiving power from an external source to power both of the secure element and the biometric authentication system; wherein the biometrically protected device is arranged such that the biometric authentication system remains inactive until the power interface receives power and the secure element provides a command message to the biometric authentication system, and wherein the command message is not provided unless the secure element has made a secure connection with the terminal and secure server.

Improvements are provided over the prior art device of WO2017/149022, and similar biometrically protected devices, since it is no longer possible to make use of the biometric authentication system at all times when power is available, since if there is no secure connection allowing the command message to be triggered, then the biometric authentication system remains inactive even if there is a power source. By requiring the secure element to have a secure connection to a terminal and server then it can be ensured that the biometric system on the protected device can only be used whilst it is connected via some trusted system. The secure connection may be a secure online connection, such as a connection to a server at some remote location from the device with communication via a network such as the internet, typically with the external source being a part of a reader that also has online connectivity for purposes of the secure connection.

The requirement for a secure connection to a server reduces the opportunity for attacks on the device, including physical attacks where there might be an attempt to separate the biometric system from the secure element, and also attempts to subvert the biometric authentication system by repeated use of messages with some form of brute force attempt to replicate biometric authorisation data. Since the proposed biometrically protected device requires a secure connection before the biometric authentication system can be used then the usage of that system may also be logged/monitored, increasing the opportunity to detect attempted hacking or fraudulent usage.

In the prior art of WO2017/149022 such advantages are not possible since the opposite approach is taken, where the secure element and/or contactless communication is not permitted until after a biometric authentication is complete.

The secure element may be a secure element for financial transactions as used, for example, on bank cards. The secure element may be arranged to establish a secure online connection with the secure server using any suitable protocols, such as those used by known secure elements of bank cards for establishing a secure online connection to a terminal and server linked with a trusted financial institution. As is established in this field of technology, a secure element is one of various form of tamper-resistant platforms capable of securely hosting applications and their confidential and cryptographic data (for example cryptographic keys). Typically this is done in accordance with the rules and security requirements set by certain well-identified trusted authorities. The secure element may be a secure microcontroller, such as a one chip secure microcontroller with a single microprocessor and it may be embedded and integrated with an electrical circuit of the biometrically protected device, for example along with other processors as discussed herein, and/or integrated with an EMV type chip, such as for an EMV compliant smartcard.

Once the secure connection has been established then the secure element transmits a command message, such as a cryptographic command signal message, to the biometric authentication system. The command message is a message for access to biometric operations within the biometric authentication system. The command message may take the form of an electronic message comprising binary encoded pulses. The message may be encoded using a cryptographic algorithm with a proprietary command sublayer. The cryptographic algorithms may be any suitable algorithm such as those currently used in the industry. In this example, the cryptographic layer of the message comprises of an encrypted data component and an authentication component. The electronic message advantageously may also include a proprietary command sublayer comprising a clear text protocol command byte followed by several control and data bytes. Advantageously, the control and data bytes can be encrypted. The command message may be between 25 and 57 bytes in length.

Upon receipt of the command message the biometric authentication system becomes active and it is possible for the user to input biometric information to thereby utilize the biometrically protected feature(s) of the device. The biometric authentication system may remain active provided that power continues to be received via the power interface.

The power interface may be for receiving power via electrical connection points on the device or via contactless power harvesting. In example embodiments the device is capable of receiving power without contact, i.e. contactless, and optionally also may receive power via a contact point. In one example, the device is a smartcard using Proximity Coupling Device (PCD) systems such as NFC/RFID systems for contactless transfer of power and/or data, as well as optionally also having a chip interface as a contact point for power and/or data transfer. Optionally, the device has no internal power source and thus may be absent any form of battery, instead being reliant on power obtained by the power interface from an external source of power. The device may include a chip interface of the type known for EMV smartcards, i.e. “chip and pin” cards, whether the device is a smartcard or not. Such a device may transfer data and power to and from contactless card readers for smartcards in similar fashion to known smartcards, although modifications may be made to more effectively allow for a biometric authorisation during periods that the device is physically connected to the reader. The biometrically protected device may include one or more antennas for contactless transfer of power and/or data, such as via contactless transmission protocols including RFID and NFC protocols. The device may include an antenna for receiving a radio-frequency excitation field from a Proximity Coupling Device (PCD), wherein the antenna is also for harvesting power from the excitation field. In examples using contactless transmission protocols the PCD may be a contactless reader. In general terms the device may be compliant with the requirements of ISO/IEC 14443 in relation to Type B Proximity Contactless Identification Cards. In some examples a single antenna is used for both power and data transfer.

In one example the biometrically authorised device includes an antenna for receiving a radio-frequency excitation field from a PCD and for harvesting power from the excitation field; wherein the biometrically authorised device is arranged to perform a method using the antenna, the method comprising: receiving, by the antenna, a command from a powered PCD; receiving, by the antenna, a substantially continuous radio-frequency excitation field whilst the PCD waits for a response to the command; activate the biometric authentication system; performing a process in the biometric authentication system; determining a period that has elapsed whilst waiting for a response; and responsive to determining that the period exceeds a predetermined threshold if the process has not been completed, sending by the antenna a request for a wait time extension to the PCD. The process performed in the biometric authentication system may be a process not required for responding to the command from the PCD, or a process providing a delayed response to the command. With this arrangement the device can prompt a longer period of continuous activation of the RF excitation field at the PCD to allow for a longer time to be taken for the process at the biometric authentication system. That process may be a process of reading and authenticating the user's biometric properties, such as a fingerprint. This use of the wait time extension permits greater freedom in relation to such processes, and can allow for longer times to be provided if needed. The proposed arrangement takes advantage of certain aspects of the standard functionality of a PCD complying with, for example, international standard ISO/IEC 14443. Particularly, whilst the PCD waits for a response to a command, it must maintain a non-pulsing, preferably a substantially continuous, radio frequency (RF) excitation field, i.e. an un-modulated excitation field.

Thus, in accordance with this arrangement, when the PCD sends a command to the biometrically protected device; the device manages the connection to the PCD using a series of wait time extensions to continue harvesting the power to drive the functionality of the biometric authentication engine, until a response is ready. The NFC Reader connection is maintained while the secure element establishes the required secure connection and sends the command message. Thus, the device may be considered to be arranged to interact with the reader in two stages. In a first stage a contactless connection is made and the secure element is operated to establish the secure connection, which may be done in a conventional fashion, before sending of the command message internally within the biometrically protected device in order to activate the biometric authentication system. At that point there may be a need for a longer period of continuous power for the biometric authentication system and thus the device may make use of the wait time extension to facilitate this.

The process performed by the biometric authentication system may be one providing a delayed response to the command, for example the command may be a “request to provide Biometric Information” command. That is to say, a response to the command from the PCD is intentionally delayed and the wait time extension is used deliberately so as to allow command processing to be performed.

The steps of “determining a period that has elapsed whilst waiting for a response; and responsive to determining that the period exceeds a predetermined threshold if the process has not been completed, sending by antenna a request for a wait time extension to the PCD” may be repeated until the process is completed and/or a response to the command has been sent. For example, after the process has been completed, the biometrically authorised device may allow the wait time to expire, if no further communication with the PCD is required. Alternatively, a response to the PCD may be sent, for example if the process was part of an authorisation step before responding to the command.

The period may be a time since the command was received or since the last wait time extension request was made. Thus, the request for a wait time extension can be sent before expiry of the current wait time to ensure that the PCD continues to maintain the RF excitation field until the process is complete.

The process performed by the biometric authentication system may be one of a biometric enrolment process or a biometric matching process, such as a fingerprint matching process.

Without using a request for a wait time extension, the maximum default time that a non-pulsing RF excitation field could be supplied is 4.949 seconds for a PCD complying with international standard ISO/IEC 14443. Thus, the method allows processes to be performed by the biometric authentication system, wherein the process may require as much as 6.0 seconds to be completed.

As discussed above, the proposed use of the wait time extension is particularly applicable to devices and readers complying with international standard ISO/IEC 14443 (although the method may be applicable also to other standards operating in a similar manner), and thus the biometrically protected device may be a proximity integrated circuit card (PICC). The PICC and PCD preferably comply with the definitions set forth in the international standard ISO/IEC 14443.

The predetermined threshold is preferably below a pre-arranged first wait time of the PICC and the PCD.

The biometric authentication system may be arranged to identify an authorised user via the biometric sensor. The biometric authentication system may comprise a processing unit for receiving an output signal from the biometric sensor and performing an authentication process to check if the output signal represents a biometric that corresponds to an enrolled biometric. An activation module may be included for controlling activation of the biometric authentication system with reference to the command message. The activation module may be a part of the processing unit or it may be a separate hardware or software module of the device. The biometric sensor and/or the processing unit may be inactive and/or inaccessible by the user until the secure element sends the command message. The authentication process may be a biometric matching process in which the output signal from the biometric is checked against a biometric template stored on the device, such as on a memory that is a part of the biometric authentication system or is accessible by the biometric authentication system. The biometric sensor could use any suitable biometric to check the identity of the user. In example embodiments fingerprint authorisation is used. The biometric sensor may hence be a fingerprint sensor.

The biometrically protected device has one or more protected feature(s), wherein access to the protected feature(s) of the device is enabled in response to identification of an authorised user via the biometric authentication system, such as via biometric data supplied through the biometric sensor to the processing unit.

The protected features of the device may be any features requiring the security of a biometric authorisation. This may include one or more of: sending certain types of data to an external system such as the secure server; allowing access to certain functions of the secure element, such as a features of the secure element relating to financial transactions; permitting a transaction between the device and an external system such as the secure server; enabling access to data stored on the device and so on.

The processing unit of the biometric authentication system may be connected to or may be a part of a control system of the device. If the device includes a processing unit at the biometric authentication system along with a separate control system then it is preferred for the processing unit to communicate with the control system using encrypted data. The control system may optionally control the use of the wait time extension signal where the biometrically protected device is arranged to use the method above to extend a period of continuously transmitted electrical field for power harvesting.

The control system of the device may include multiple processors. This may include the processing unit that receives the signal from the biometric sensor. Other processors may include a control processor for controlling basic functions of the device, such as communication with other devices (e.g. via contactless technologies), activation and control of receivers/transmitters, activation and control of the secure element. The various processors could be embodied in separate hardware elements, or could be combined into a single hardware element, possibly with separate software systems.

As noted above, some example embodiments relate to smartcards. Other forms of biometrically protected device are also possible, such as control tokens of various types, wearables and/or security devices for accessing secure areas or secure storage of data. The biometrically protected device is advantageously a single unit incorporating the secure element, the biometric authentication system and the power interface, for example the parts of the biometrically protected device may be all packaged in a body of the device, such as being within a single housing. The proposed device is thus to be differentiated from broader systems where there might be separate terminals for power connectivity and/or separate devices for biometric sensing.

The biometrically protected device may be a single portable device, by which is meant a device designed for being carried by a person, typically a device small and light enough to be carried conveniently. The device can be arranged to be carried within a pocket, handbag or purse, for example, or it may be a wearable device that is incorporated into a worn object such as a watch, wristband, or clothing, amongst others. The biometrically protected device may be a smartcard such as a fingerprint authorisable contactless card. The device may also or alternatively act as a control token for controlling access to a system external to the control token, such as a one-time-password device for access to a computer system or a fob for a vehicle keyless entry system. The device is preferably also portable in the sense that it does not rely on a wired power source. Optionally the device has no internal power source and thus may be absent any form of battery, instead being reliant on power obtained by the power interface.

The biometrically protected device may be a single-purpose device, i.e. a device for interacting with a single external system or network or for interacting with a single type of external system or network, wherein the device does not have any other purpose. Thus, the device is to be distinguished from complex and multi-function devices such as smartphones and the like. That is to say, in example embodiments the biometrically protected device is not a smartphone and thus may not have smartphone functionalities such as being absent one or more of a telecommunications system, internal power source, touchscreen display and/or internet browser. The biometrically protected device may nonetheless have multiple operating modes, each of which involves interacting with the same type of external system or network, for example the ability to operate as a card for two different bank accounts, or the ability to interact with PCDs as an access card or as a payment card.

Where the biometrically protected device is a smartcard then the smartcard may be any one of: an access card, a credit card, a debit card, a pre-pay card, a loyalty card, an identity card, or the like. The smartcard may include a combination of functions and/or modes allowing it to act as a combination of the above smartcard types as required by the user.

Generally, the smartcard may comply with ISO 7816, which is the specification for a smartcard. The smartcard optionally has a width of between 85.47 mm and 85.72 mm, and a height of between 53.92 mm and 54.03 mm. The smartcard may have a thickness less than 0.84 mm, and examples may have a thickness of less than about 0.76 mm. The thickness of mass produced cards may vary within a thickness tolerance, such as a tolerance of ±0.08 mm, and hence the smartcard may have a design thickness of 0.76 mm allowing for a tolerance of ±0.08 mm with no card being thicker than 0.84 mm as a consequence. The smartcard may include one or more antennas for contactless transfer of power and/or data, such as via contactless communication protocols. In some examples a single antenna is used for both power and data transfer.

It is advantageous for the device to be arranged so that it is impossible to extract the data used for identifying users via the biometric authorisation. The transmission of this type of data outside of the device is considered to be one of the biggest risks to the security of the device.

To avoid any need for communication of the biometric data outside of the device then the device may be able to self-enroll, i.e. the device may be arranged to enroll an authorised user by obtaining biometric data via the biometric sensor. The processing unit may be capable of performing both an enrolment process and a matching process on a biometric, such as a fingerprint of a finger presented to a fingerprint sensor. This also has advantages arising from the fact that the same sensor with the same geometry is used for the enrolment as for the biometric authorisation. The biometric data can be obtained more consistently in this way compared to the case where a different sensor on a different device is used for enrolment. With biometrics and in particular with fingerprints, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced.

In accordance with the proposed device, both the matching and enrolment scans may be performed using the same biometric sensor. As a result, scanning errors can be balanced out because, for example, if a user tends to present their finger to a fingerprint sensor with a lateral bias during enrolment, then they are likely to do so also during matching.

The biometric authentication system may have an enrolment mode in which a user may enroll their biometric data via the biometric sensor, with the biometric data generated during enrolment being stored on a memory. The processing unit of the biometric authentication system, where present, may correspondingly have an enrolment mode. The biometric authentication system may be in the enrolment mode when the device is first provided to the user, so that the user can immediately enroll their biometric data. The first enrolled user may be provided with the ability to later prompt an enrolment mode for subsequent users to be added, for example via input on an input device of the device after identification has been confirmed. Alternatively or additionally it may be possible to prompt the enrolment mode of the biometric authentication system via outside means, such as via interaction between the device and a secure external system, which may be a secure external system controlled by the manufacturer or by another authorised entity.

Viewed from a second aspect, the invention provides a system comprising: one or more biometrically protected device(s) as discussed above; a secure server for making a secure connection with the secure element; and a reader for connection to the biometrically protected device for data and power transfer. The reader may be a contactless card reader and/or may be a PCD as discussed above. The biometrically protected device may have any of the features discussed above. In one example embodiment the reader is a contactless card reader and the biometrically protected device is a smartcard.

Viewed from a third aspect the invention provides a method for controlling a biometrically protected device as described in the first aspect. Thus, the method is for controlling a device comprising: a secure element for communications with a secure server; a biometric authentication system including a biometric sensor; and a power interface for receiving power from an external source and for powering both of the secure element and the biometric authentication system; wherein the method includes keeping the biometric authentication system inactive until the power interface receives power and the secure element provides a command message to the biometric authentication system to activate it, and wherein the command message is not provided unless the secure element has made a secure connection with the secure server.

The method may use a biometrically protected device as described in the first aspect and optionally with any of the other features discussed above.

The method may include receiving power from an external source via the power interface, making a secure connection to the secure server using the secure element, transmitting the command message to the biometric authentication system from the secure element, and activating the biometric authentication system in response to the command message. As discussed above, the secure connection may be a secure online connection, such as a connection to a server at some remote location from the device with communication via a network such as the internet. The method may include monitoring usage of the biometrically protected device via the secure connection, which may be done for the purpose of increasing the security of the device, such as by enabling opportunities to detect attempted hacking or fraudulent usage of the device.

The secure element may be a secure element for financial transactions as used, for example, on bank cards, and the method may hence include using the biometric authentication system in order to verify the user's identity and to thereby permit a financial transaction to occur. The device may alternatively or additionally involve other protected features as discussed above.

In one example the biometrically authorised device includes an antenna for receiving a radio-frequency excitation field from a PCD (such as a NFC reader) and for harvesting power from the excitation field; and the method includes: receiving, by the antenna, a command from a powered PCD; receiving, by the antenna, a substantially continuous radio-frequency excitation field whilst the PCD waits for a response to the command; activate the biometric authentication system; performing a process in the biometric authentication system; determining a period that has elapsed whilst waiting for a response; and responsive to determining that the period exceeds a predetermined threshold if the process has not been completed, sending by the antenna a request for a wait time extension to the PCD. The process performed in the biometric authentication system may be a process not required for responding to the command from the PCD, or a process providing a delayed response to the command. The method using wait time extension may include further features as discussed above in relation to the device of the first aspect.

Viewed from a fourth aspect, the present invention provides a computer program product for a biometrically protected device comprising: a secure element for communications with a secure server; a biometric authentication system including a biometric sensor; and a power interface for receiving power from an external source and for powering both of the secure element and the biometric authentication system; wherein the computer program product, when executed on the device, will configure the biometric authentication system to remain inactive until the power interface receives power and the secure element provides a command message to the biometric authentication system, and wherein the computer program product, when executed on the device, will configure the secure element so that the command message is not provided unless the secure element has made a secure connection with the secure server.

The computer program product may be for execution on a device as described in the first aspect and optionally a device with any of the other features discussed above.

Certain preferred embodiments of the present invention will now be described in greater detail, by way of example only and with reference to the accompanying Figures, in which:

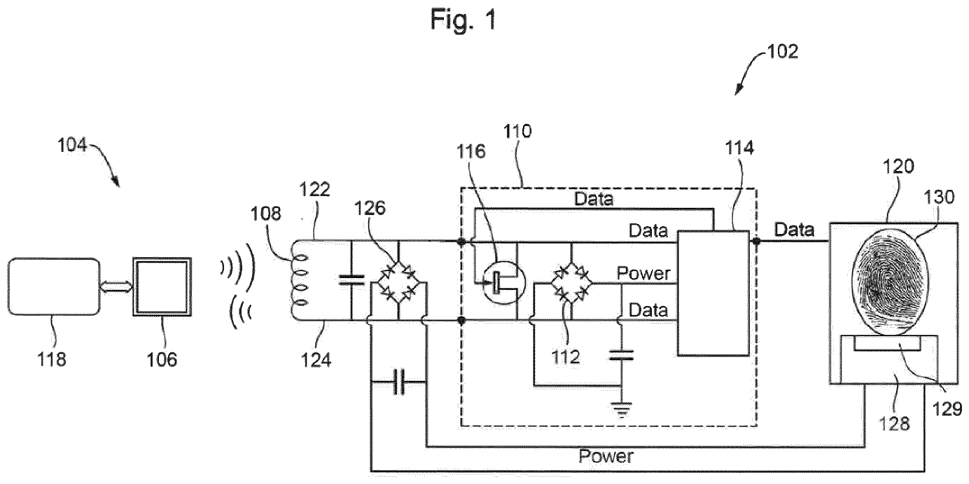

FIG. 1 illustrates a circuit for a passive contactless device incorporating biometric authorisation via a fingerprint scanner;

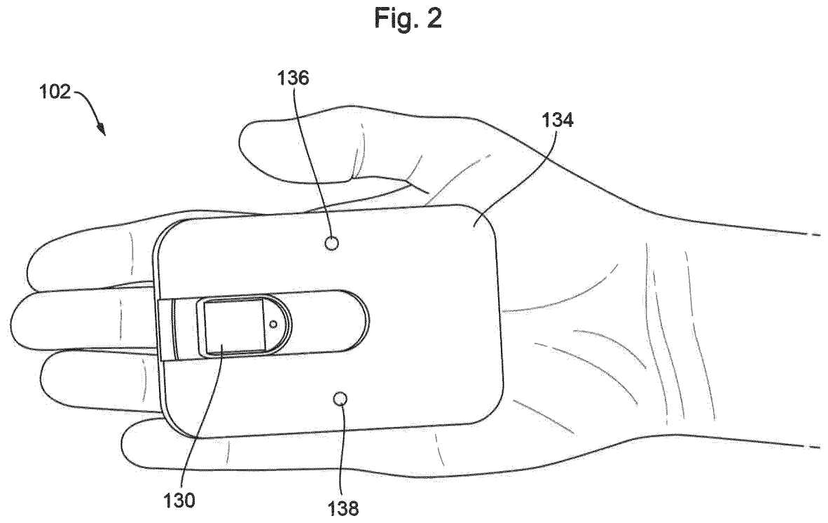

FIG. 2 illustrates a first example of the passive contactless device having an external housing incorporating the fingerprint scanner;

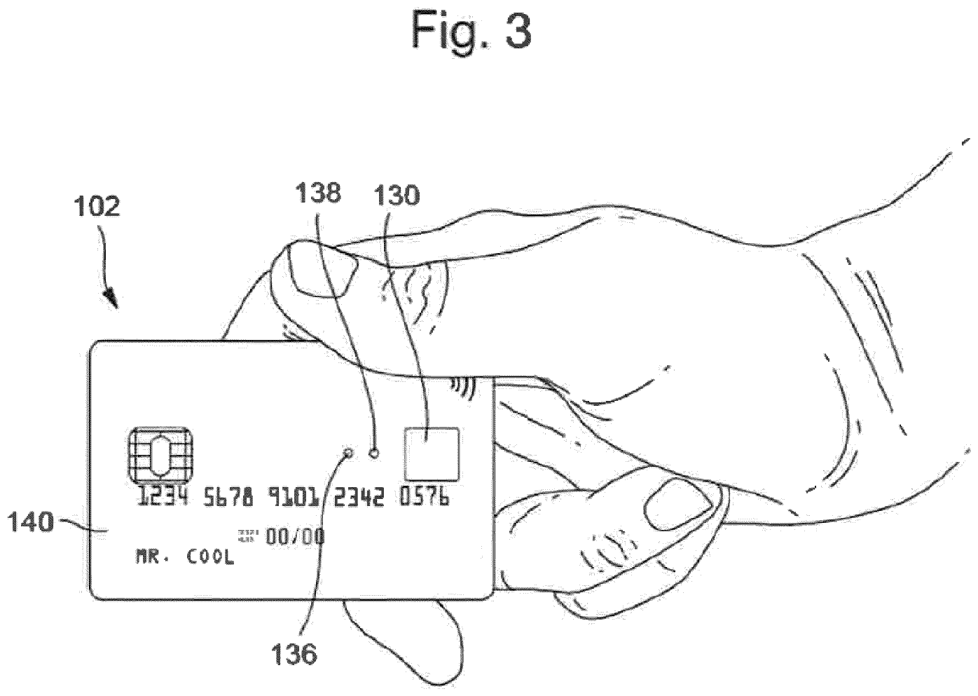

FIG. 3 illustrates a second example of the passive contactless device where the fingerprint scanner is exposed from a laminated card body;

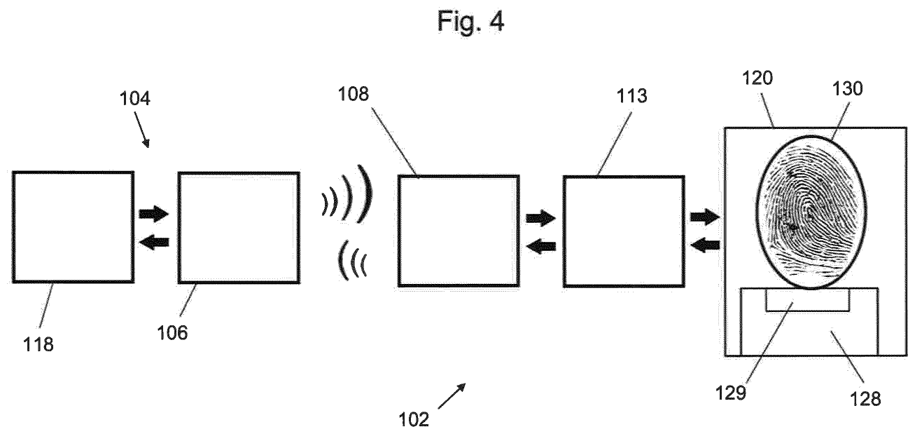

FIG. 4 is a schematic diagram of a fingerprint authorised wireless control token or wearable device; and

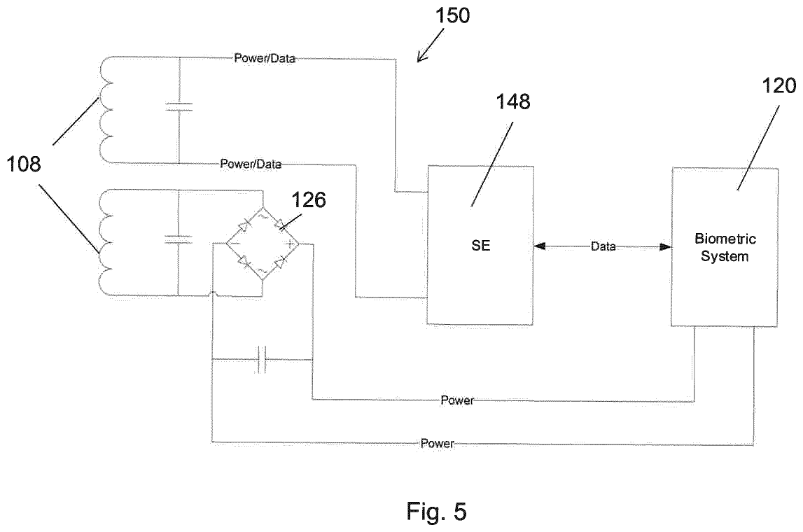

FIG. 5 illustrates an alternative circuit for the passive contactless device incorporating biometric authorisation via a fingerprint scanner.

The example embodiments concern the use of a biometrically protected device 102 where a biometric authorisation system 120 is kept inactive unless certain criteria are fulfilled. This is done by a suitable hardware or software implementation of an activation module 129. The activation module 129 in some examples is incorporated in a processing unit 128 of the biometric authorisation system 120, which can be a dedicated processing unit 128 integrated with the biometric authorisation system 120 as discussed below, or in alternative implementations may be a separate hardware/software module on the device 102. The biometrically protected device 102 further includes a secure element, which may be integrated into a control circuit 114 as in FIG. 1, a control module 113 as in FIG. 4 or may be a separate secure element 148 within a separate circuit 150 as in FIG. 5.

In FIGS. 1, 2 and 3 the biometric authorised device 102 is a smartcard 102 and in FIG. 4 it is a wireless control token or a wearable device 102. The circuit of FIG. 5 may be used for any biometrically protected device including a secure element of the type used for financial transactions, and is focused on devices with a payment capability. This would most typically be present in a smartcard form factor, but could also be implemented in a wearable device or some other form of device.

Typically the circuit arrangement of FIG. 1 may be used for smartcards 102 as shown in FIGS. 2 and 3, which are used for contactless access control systems, whereas the circuit arrangement of FIG. 5 may be used for contactless payment cards, e.g. credit cards.

The examples use RFID/NFC protocols for proximity contactless communications. In these examples a fingerprint sensor 130 is used to provide a biometric authorisation before full access to the features of the smartcard device 102 or control token/wearable device 102 is permitted. This fingerprint sensor 130 is provided as a part of a biometric authentication system in the form of fingerprint authorisation module 120 that also includes a dedicated processing unit 128. The processing unit 128 interacts with other processors/controllers of the biometrically protected device 102 in order to indicate when the user's identify has been confirmed biometrically. For example, the processing unit 128 can interact with the control circuit 114 of FIG. 1 or the control module 113 of FIG. 4 and this communication can be encrypted. There may be a data line for this purpose, for example a data line making a direct link between the control circuit 114 and the fingerprint authorisation module 120.

FIG. 1 shows the architecture of a passive contactless biometrically protected device 102 incorporating the activation module 129 for the fingerprint authentication system 120, 130. A powered contactless reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the contactless device 102, such as an antenna 108 comprising a tuned coil and capacitor, and then passed to a contactless chip 110. The received signal is rectified by a bridge rectifier 112, and the DC output of the rectifier 112 is provided to a control circuit 114 that controls the messaging from the chip 110.

Data output from the control circuit 114 is connected to a field effect transistor 116 that is connected across the antenna 108. By switching on and off the transistor 16, a signal can be transmitted by the contactless device 102 and decoded by suitable control circuits 118 in the reader 104. This type of signalling is known as backscatter modulation and is characterised by the fact that the reader 104 is used to power the return message to itself.

As used herein, the term “passive contactless device” should be understood to mean a contactless device 102 in which the contactless chip 110 is powered only by energy harvested from an RF excitation field, for example generated by the contactless reader 104. That is to say, a passive contactless device 102 relies on the contactless reader 104 to supply its power for broadcasting. A passive contactless device 102 would not normally include a battery, although a battery may be included to power auxiliary components of the circuit (but not to broadcast); such devices are often referred to as “semi-passive contactless devices”.

Similarly, the term “passive fingerprint/biometric authentication engine” should be understood to mean a fingerprint/biometric authentication engine that is powered only by energy harvested from an RF excitation field, for example an RF excitation field generated by the contactless reader 118.

The antenna 108 comprises a tuned circuit, in this arrangement including an induction coil and a capacitor, which are tuned to receive an RF signal from the contactless reader 104. When exposed to the excitation field generated by the contactless reader 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and supplied to the fingerprint authentication engine 120.

The fingerprint authentication engine 120 includes the processing unit 128, the activation module 129, and the fingerprint sensor 130, which is preferably an area fingerprint sensor 130 as shown in FIGS. 2 and 3. The fingerprint authentication engine 120 is passive, and hence is powered only by the voltage output from the antenna 108. The processing unit 128 comprises a microprocessor that is chosen to be of very low power and very high speed, so as to be able to perform biometric matching in a reasonable time.

The fingerprint authentication engine 120 is not activated by the activation module 129 until it receives power from the antenna 108 and also receives a command message from the secure element, which as noted above may be embedded in the control circuit 114 or the control module 113 of the device 102. The secure element is arranged to make a secure connection with a secure server via the contactless reader 104, such as a connection of the type used for financial transactions using EMV smartcards. When the secure element has established a secure connection then it sends a command message to the activation module 129, which then activates the fingerprint authentication engine 120 and/or the fingerprint sensor 130. The secure connection may be a secure online connection, such as a connection to a server at some remote location from the contactless device 102 with communication via a network such as the internet. This adds to the security of the device 102 since the opportunity to for “offline” use of the fingerprint system is removed.

The command message takes the form of an electronic message comprising binary encoded pulses and is typically a message between 25 and 57 bytes in length. The message is encoded using an industry standard cryptographic algorithm with a proprietary command sublayer. The cryptographic layer of the message comprises of an encrypted data component and an authentication component. The proprietary command sublayer comprises a clear text protocol command byte followed by several control and data bytes.

The fingerprint authentication engine 120 is arranged to scan a finger or thumb presented to the fingerprint sensor 130 and to compare the scanned fingerprint of the finger or thumb to pre-stored fingerprint data using the processing unit 128. If a match is determined, then the user is allowed to access protected features of the device 102, which may for example be a payment function via the secure element.

FIG. 2 shows an exemplary housing 134 of the contactless device 102. The circuit shown in FIG. 1 is housed within the housing 134 such that a scanning area of the fingerprint sensor 130 is exposed from the housing 134. FIG. 3 shows an alternative implementation in which the circuit shown in FIG. 1 is laminated within a card body 140, with the fingerprint sensor 130 mounted to the laminated card such that a scanning area of the fingerprint sensor 130 is exposed from the laminated body 140.

Prior to use the user of the contactless device 102 must first enroll his fingerprint date onto a “virgin” device, i.e. not including any pre-stored biometric data. This may be done by presenting his finger to the fingerprint sensor 130 one or more times, preferably at least three times and usually five to seven times.

The housing 134 or card body 140 may include indicators for communication with the user of the contactless device, such as the LEDs 136, 138 shown in FIGS. 2 and 3. During enrolment, the user may be guided by the indicators 136, 138, which tell the user if the fingerprint has been enrolled correctly. The LEDs 136, 138 on the contactless device 102 may communicate with the user by transmitting a sequence of flashes consistent with instructions that the user has received with the contactless device 102.

With fingerprint biometrics, one common problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing 134 or card body 140 around each fingerprint sensor can be designed to guide the finger in a consistent manner each time it is read. If a fingerprint is scanned with a number of different terminals, each one being slightly different, then errors can occur in the reading of the fingerprint. Conversely, if the same fingerprint sensor is used every time then the likelihood of such errors occurring is reduced.

As described above, the present contactless device 102 includes a fingerprint authentication engine 120 having an on board fingerprint sensor 130 as well as the capability of enrolling the user, and thus both the matching and enrolment scans may be performed using the same fingerprint sensor 130. As a result, scanning errors can be balanced out because, if a user tends to present their finger with a lateral bias during enrolment, then they are likely to do so also during matching.

Thus, the use of the same fingerprint sensor 130 for all scans used with the contactless device 102 significantly reduces errors in the enrolment and matching, and hence produces more reproducible results.

In the present arrangement, the power for the contactless chip 110 and the fingerprint authentication engine 120 is harvested from the excitation field generated by the contactless reader 104. That is to say, the contactless device 102 is a passive contactless device, and thus has no battery, but instead uses power harvested from the reader 104 in a similar way to a conventional, non-biometric contactless device.

The rectified output from second bridge rectifier 126 is used to power the fingerprint authentication engine 120. However, the power required for this is relatively high compared to the power demand for the components of a normal contactless device. For this reason, it is not straightforward to incorporate a fingerprint sensor 130 into a passive contactless device 102.

One problem that arises when seeking to power the fingerprint authentication engine 120 is that typical contactless readers 104 pulse their excitation signal on and off so as to conserve energy, rather than steadily emitting the excitation signal. Often this pulsing results in a duty cycle of useful energy of less than 10% of the power emitted by steady emission. This can be insufficient to power the fingerprint authentication engine 120.

Contactless readers 104 typically conform to ISO/IEC 14443, the international standard that defines proximity cards used for identification, and the transmission protocols for communicating with them. When communicating with such contactless devices 104, the contactless device 102 can take advantage of a certain feature of these protocols, which will be described below, to switch the excitation signal from the contactless reader 104 to continuous for long enough to perform the necessary calculations.

The ISO/IEC 14443-4 standard defines the transmission protocol for proximity cards. ISO/IEC 14443-4 dictates an initial exchange of information between a proximity integrated circuit card (PICC), i.e. the contactless device 102, and a proximity coupling device (PCD), i.e. the contactless reader 104, that is used, in part, to negotiate a frame wait time (FWT). The FWT defines the maximum time for PICC to start its response after the end of a PCD transmission frame. The PICC can be set at the factory to request an FWT ranging from 302 μs to 4.949 seconds. Certain protocols compliant with ISO/IEC 14443-4 may dictate additional restrictions on the FWT. For example, the EMVCo protocol commonly used for payment devices sets a maximum FWT of 38.66 ms.

ISO/IEC14443-4 dictates that, when the PCD sends a command to the PICC, such as a request for the PICC to provide an identification code, the PCD must maintain an RF field and wait for at least one FWT time period for a response from the PICC before it decides a response timeout has occurred. If the PICC needs more time than FWT to process the command received from the PCD, then the PICC can send a request for a wait time extension (S(WTX)) to the PCD, which results in the FWT timer being reset back to its full negotiated value. The PCD is then required to wait another full FWT time period before declaring a timeout condition.

If a further wait time extension (S(WTX)) is sent to the PCD before expiry of the reset FWT, then the FWT timer is again reset back to its full negotiated value and the PCD is required to wait another full FWT time period before declaring a timeout condition.

This method of sending requests for a wait time extension can be used to keep the RF field on for an indefinite period of time. While this state is maintained, communication progress between the PCD and the PICC is halted and the RF field can be used to harvest power to drive other processes that are not typically associated with smart card communication, such as fingerprint enrolment or verification.

Thus, with some carefully designed messaging sequences between the card and the reader more power can be extracted from the reader to enable an authentication cycle with reduced constraints on the time and/or power requirements. This method harvesting of power overcomes one of the major problems of powering a fingerprint authentication engine 120 in an RFID device 102 using harvested power, particularly for when a fingerprint is to be enrolled since this can require a longer time for activation of the fingerprint authentication system 120, 130.

Furthermore, this power harvesting method allows a larger fingerprint sensor 130 to be used, and particularly an area fingerprint scanner 130, which outputs data that is computationally less intensive to process.

FIG. 4 shows the basic architecture of an alternative arrangement in which the smartcard 102 is replaced by a wireless control token 102 or equivalently a wearable 102, such as a watch or a watch strap. In the discussion below the references to a control token 102 should be taken to include a wearable acting as a control token. The same contactless card reader 104 may still be used or it may be replaced by an external system or device 104 with equivalent capabilities. The wearable 102 may be a watch strap or wristband with contactless capabilities, such as for permitting access to secure locations or secure systems.

The external system 104 includes a transceiver 106 for receiving a transmission from the control token or wearable 102. In these examples the external system 104 includes a radio frequency receiver, and it also has a transmitting capability as provided by the transceiver 106. The external system 104 also includes access controlled elements 118 in communication with the transceiver 106, as well as means for communicating with the secure server, such as through the internet as discussed above. When the transceiver 106 receives an appropriate signal then it will permit access to the access controlled elements 118 and/or actuate certain features of the access controlled elements 118.

The wireless control token 102 includes a transceiver 108 for transmitting a radio frequency signal to the transceiver of the external system 104. The wireless control token 102 includes a radio frequency transmitter, and it also has a receiving capability as is provided by the transceiver 108. The wireless control token 102 further includes a control module 113 and a biometric authorisation module in the form of a fingerprint authentication engine 120. Power harvested from the external system 104 can be used to power the transceiver 108, the control module 113 and the fingerprint authentication engine 120.

As with the smartcard 102 above, the control token or wearable 102 requires an online connection to a secure server before the secure element, which can be embedded in the control module 113, issues a command message that activates the fingerprint authentication engine 120. The command message can be an electronic message as discussed above. In this respect the operation of the two types of device is broadly similar.

The fingerprint authentication engine 120 includes a processing unit 128 and a fingerprint sensor 130, which may be an area fingerprint sensor 130. The processing unit 128 comprises a microprocessor that is chosen to be of very low power and very high speed, so as to be able to perform biometric matching in a reasonable time and to maximise the lifespan of the power source. The processing unit 128 could be a part of the control module 113, i.e. implemented on common hardware and/or using common software elements, although typically it is separate and it is a dedicated processor connected to the fingerprint sensor 130. An activation module 129 is provided in the processing unit 128 in order to control activation of the fingerprint authentication engine 120 as described above. The fingerprint authentication engine 120 is arranged to scan a finger or thumb presented to the fingerprint sensor 130 and to compare the scanned fingerprint of the finger or thumb to stored reference fingerprint data using the processing unit 128. The stored reference fingerprint data could be stored in encrypted form in a non-volatile memory within the processing unit 128 or the control module 113. A determination is then made as to whether the scanned fingerprint matches the reference fingerprint data using a fingerprint template and matching of minutiae, for example.

If a match is determined then the fingerprint authentication engine 120 communicates this to the control module 113. The control module 113 may then permit/activate protected functions of the device, typically using the transceiver 108 to conduct some form of authentication and/or transaction with the external system 104.

Prior to use a new user of the control token 102 must first enrol their fingerprint date onto a “virgin” device, i.e. not including any pre-stored biometric data. This enrolment can be similar to that discussed above for the smartcard example.

The control token 102 may have a body 134, 140 that includes indicators for communication with the user of the control token 102, such LEDs or an LCD display. During enrolment, the user may be guided by the indicators, which tell the user if the fingerprint has been enrolled correctly. After several presentations of the finger, the fingerprint will have been enrolled and the device 102 will then respond to the fingerprint of the authorised user. The indicators may also be used during subsequent authentication in order to indicate to the user when their fingerprint is recognised and when access to the access controlled features 118 of the external system 104 has been permitted.

FIG. 5 shows an arrangement for a circuit of a smartcard 102 or other biometrically protected device where there is a separate secure element 148 in a dedicated sub-circuit 150. Thus, in this example the antenna 108 has two parts that separately provide power and/or data to either the secure element 148, or the biometric system as embodied via the fingerprint authentication engine 120. It will be appreciated that other features of the circuit, such as the rectifier 126 and parts of the fingerprint authentication engine 120, may be similar to those parts discussed above in relation to FIG. 1. Thus, the fingerprint authentication engine 120 can include a processing unit 128 and a fingerprint sensor 130, which may be an area fingerprint sensor 130, as well as an activation module 129 that can be in communication with the secure element 148. The fingerprint authentication engine 120 and the parts thereof can operate as discussed above. As with the other examples above, the circuit of FIG. 5 is arranged such that the device requires an online connection before the secure element 148 issues a command message that activates the fingerprint authentication engine 120 via the activation module 129.

The circuit of FIG. 5 could be incorporated into a smartcard 102 as described above with reference to FIG. 2 or FIG. 3. Alternatively this circuit could be used with a different form of biometrically protected device, such as a control token or wearable.

1. A biometrically protected device comprising:
a secure element for communications with a secure server;
a biometric authentication system including a biometric sensor, wherein the biometric authentication system is for controlling access to one or more protected feature(s) of the device; and
a power interface for receiving power from an external source and for powering both of the secure element and the biometric authentication system;
wherein the biometrically protected device is arranged such that the biometric authentication system remains inactive until the power interface receives power and the secure element provides a command message to the biometric authentication system, and wherein the command message is not provided unless the secure element has made a secure connection with the secure server.

2. A device as claimed in claim 1, wherein the secure element is arranged to make a secure connection in the form of a secure online connection to the secure server, wherein the server is at some remote location from the device.

3. A device as claimed in claim 1, wherein the secure element is a secure element for financial transactions and the protected feature(s) include features of the secure element relating to financial transactions.

4. A device as claimed in claim 1, wherein once the secure connection has been established then the secure element transmits the command message to the biometric authentication system, and wherein the command message is an electronic message comprising binary encoded pulses, with the content of the message including a cryptographic layer and a proprietary command sublayer.

5. A device as claimed in claim 1, wherein the device is arranged such that upon receipt of the command message the biometric authentication system becomes active and it is possible for the user to input a biometric for authentication by the biometric authentication system to thereby enable access the biometrically protected feature(s) of the device; and wherein after activation the biometric authentication system remains active provided that power continues to be received via the power interface.

6. A device as claimed in claim 1, wherein the device is capable of contactless transfer of power and/or data using the power interface.

7. A device as claimed in claim 1, comprising one or more antennas for contactless transfer of power and/or data via contactless transmission protocols.

8. A device as claimed in claim 1, including an antenna for receiving a radio-frequency excitation field from a Proximity Coupling Device (PCD) and for harvesting power from the excitation field; wherein the device is arranged to perform a method using the antenna, the method comprising: receiving, by the antenna, a command from a powered PCD; receiving, by the antenna, a substantially continuous radio-frequency excitation field whilst the PCD waits for a response to the command; activate the biometric authentication system; performing a process in the biometric authentication system; determining a period that has elapsed whilst waiting for a response; and responsive to determining that the period exceeds a predetermined threshold if the process has not been completed, sending by the antenna a request for a wait time extension to the PCD.

9. A device as claimed in claim 8, wherein the process performed by the biometric authentication system is one providing a delayed response to the command, wherein a response to the command from the PCD is intentionally delayed making use of the wait time extension so as to allow command processing to be performed.

10. A device as claimed in claim 1, comprising an EMV chip interface that is in accordance with standards set for EMV smartcards.

11. A device as claimed in claim 1, wherein the biometrically protected device is a smartcard.

12. A device as claimed in claim 11, wherein the smartcard has a width of between 85.47 mm and 85.72 mm, a height of between 53.92 mm and 54.03 mm, and a thickness less than 0.84 mm.

13. A system comprising: one or more biometrically protected device(s) as claimed in claim 1; a secure server for making a secure connection with the secure element of the biometrically protected device; and a reader for connection to the biometrically protected device for data and power transfer, wherein the reader provides for an online connection with the secure server, and wherein the secure server is at a different location to the reader.

14. A system as claimed in claim 13, wherein the reader is contactless card reader and the biometrically protected device is a smartcard.

15. A method for controlling a biometrically protected device as claimed in claim 1, the method comprising: keeping the biometric authentication system inactive until the power interface receives power and the secure element provides a command message to the biometric authentication system to activate it, wherein the command message is not provided unless the secure element has made a secure connection with the secure server.

16. A method as claimed in claim 15, wherein the secure element is for authorisation of financial transactions via the secure server and the protected feature(s) include features of the secure element relating to financial transactions, the method comprising: after activation of the biometric authentication system by the command message, receiving a biometric input from a user; authenticating the biometric input via the biometric authentication system; and in the event that the user is an authorised user, enabling access to the features of the secure element relating to financial transactions.

17. A computer program product for a biometrically protected device comprising: a secure element for communications with a secure server; a biometric authentication system including a biometric sensor; and a power interface for receiving power from an external source and for powering both of the secure element and the biometric authentication system; wherein the computer program product, when executed on the device, will configure the biometric authentication system to remain inactive until the power interface receives power and the secure element provides a command message to the biometric authentication system, and wherein the computer program product, when executed on the device, will configure the secure element so that the command message is not provided unless the secure element has made a secure connection with the secure server.

18. (canceled)
